(19) United States
(12) Patent Application Publication
(10) Pub. No.: US 2017/0138204 A1
(43) Pub. Date: May 18, 2017

(54) COOLING STRUCTURE AND GAS TURBINE

(71) Applicant: KABUSHIKI KAISHA TOSHIBA, Tokyo (JP)

(72) Inventors: Tomohiko JIMBO, Fujisawa (JP); Biswas DEBASISH, Shiki (JP)

(73) Assignee: KABUSHIKI KAISHA TOSHIBA

(21) Appl. No.: 15/259,762

(22) Filed: Sep. 8, 2016

(30) Foreign Application Priority Data
Nov. 17, 2015 (JP) 2015-225095

(51) Int. Cl. F01D 5/18

(52) U.S. Cl. CPC F01D 5/187; F05D 2220/32; F05D 2240/30; F05D 2250/185; F05D 2260/2212; F05D 2260/22141

(57) ABSTRACT

According to one embodiment, a cooling structure includes: a flow path provided in a blade and configured to cause a cooling medium to flow therethrough; a plurality of ribs provided in the flow path and alternately deviated and provided to be substantially parallel to a flowing direction of the cooling medium, one of the ribs being a first rib, the first rib being upstream in the flowing direction, one of the ribs being a second rib, the second rib being downstream in the flowing direction and being parallel to the first rib; and a turbulent flow generator provided between the first rib and the second rib.

### CROSS-REFERENCE TO RELATED APPLICATION

This application claims priority from Japanese Patent Application No. 2015-225095 filed on Nov. 17, 2015, the contents of which are incorporated herein by reference in their entirety.

### FIELD

Embodiments described herein relate generally to a blade cooling structure and a gas turbine using the same.

### BACKGROUND

In a gas turbine, high pressure air compressed by a compressor is send to a combustor, and fuel is combusted using the air as an oxidant, and this generated high temperature and high pressure gas is fed to a turbine.

In the turbine, as a moving blade array is rotated by the high temperature and high pressure gas generated in the combustor, power or thrust is obtained.

In a gas turbine for power generation, the obtained power is extracted as rotary shaft power to drive a generator to be converted into energy such as electric power or the like.

As one means configured to improve performance of a gas turbine, a temperature and a pressure of a working gas are increased.

When the temperature of the working gas is increased, the durability temperature of the turbine should be satisfied, and in addition to development of a material, a thermal barrier coating, or the like, a cooling technology should be developed.

A cooling method may generally be internal convection cooling in which a cooling medium flows through a flow path provided in a blade, film cooling in which a cooling medium is jetted from a blade surface and a thin film of the cooling medium is provided around a blade, or the like.

Air is generally used as the cooling medium, and here, cooling air is extracted from a compressor.

Hereinafter, an example of a cooling structure of a turbine blade will be described with reference to FIGS. 9A to 9C.

FIG. 9A is a perspective view showing a gas turbine blade.

FIG. 9B is a cross-sectional view showing an internal structure of the gas turbine blade.

FIG. 9C is a cross-sectional view taken along line D-D of FIG. 9B.

As shown in FIG. 9B, a blade 101 is fixed to a platform 102, and a serpentine cooling medium path 103 and a pin fin cooling medium path 105, in which a plurality of pin fins 106 are provided at a blade trailing edge, are provided in the blade 101.

A cooling medium flows through the blade 101 from the platform 102 in directions of 301a to 301d and comes out of the blade 101 in directions of 302a to 302d.

A plurality of ribs 104 are provided in the serpentine cooling medium path 103 to promote heat transfer by changing the flow into a turbulent flow.

The ribs used for a conventional internal convection cooling are provided to be perpendicular or slightly inclined with respect to a direction of a flow path or a main stream.

For this reason, a resistance of the flow increases, and pressure loss is increased.

As shown in FIG. 10, parts of a flow 307 and a flow 308 in a flow path 110 become a flow 309 separated downstream from the ribs 104 and form a vortex 306a.

In addition, a vortex 306b is also formed upstream from the ribs 104.

Parts of the vortex 306a and the vortex 306b have a small coefficient of heat transfer.

When the flow 309 which is separated is stuck to a blade inner wall surface 107 again, the coefficient of heat transfer is increased at the downstream side.

In this way, the coefficient of heat transfer is locally decreased in the conventional ribs to cause non-uniformity in cooling performance due to an influence of the vortex generated by the separation of the flow.

In the conventional cooling structure, the non-uniformity of the cooling performance occurs due to an increase in pressure loss by resistances of the ribs or a local decrease in the coefficient of heat transfer.

### BRIEF DESCRIPTION OF THE DRAWINGS

FIG. 1A is a schematic cross-sectional view showing the entire configuration of a gas turbine blade according to a first embodiment.

FIG. 1B is a cross-sectional view taken along line A-A of FIG. 1A.

FIG. 1C is an enlarged cross-sectional view showing the relevant part of the gas turbine blade which is indicated by F of FIG. 1B.

FIG. 2A is a configuration view showing an internal flow path of the gas turbine blade according to the first embodiment.

FIG. 2B is a configuration view showing an internal flow path of the gas turbine blade according to the first embodiment.

FIG. 3 is a configuration view showing a flow in an internal flow path of the gas turbine blade according to the first embodiment.

FIG. 4 is a configuration view showing a modified example according to the first embodiment.

FIG. 5A is a schematic cross-sectional view showing the entire configuration of a gas turbine blade according to a second embodiment.

FIG. 5B is a cross-sectional view taken along line B-B of FIG. 5A.

FIG. 5C is a cross-sectional view taken along line C-C of FIG. 5A.

FIG. 5D is an enlarged cross-sectional view showing the relevant part of the gas turbine blade which is indicated by H of FIG. 5C.

FIG. 6 is a configuration view showing an internal flow path of the gas turbine blade according to the second embodiment.

FIG. 7 is a configuration view showing a flow in the internal flow path of the gas turbine blade according to the second embodiment.

FIG. 8A is a configuration view showing modified examples according to the first and second embodiments and is a cross-sectional view showing a turbine cooling blade.

FIG. 8B is a configuration view showing a first modified example according to the first and second embodiments and is an enlarged cross-sectional view showing the relevant part of the turbine cooling blade which is indicated by I of FIG. 8A.

FIG. 8C is a configuration view showing a second modified example according to the first and second embodiments and is an enlarged cross-sectional view showing the relevant part of the turbine cooling blade which is indicated by I of FIG. 8A.

FIG. 9A is a configuration view showing an example of a structure of a conventional gas turbine blade and is a perspective view showing a gas turbine blade.

FIG. 9B is a configuration view showing an example of a structure of a conventional gas turbine blade and is a cross-sectional view showing an internal structure of the gas turbine blade.

FIG. 9C is a cross-sectional configuration view showing an example of a structure of a conventional gas turbine blade and is a cross-sectional view taken along line D-D of FIG. 9B.

FIG. 10 is a configuration view showing a flow in a conventional internal flow path.

### DETAILED DESCRIPTION

According to one embodiment, a cooling structure includes: a flow path provided in a blade and configured to cause a cooling medium to flow therethrough; a plurality of ribs provided in the flow path and alternately deviated and provided to be substantially parallel to a flowing direction of the cooling medium, one of the ribs being a first rib, the first rib being upstream in the flowing direction, one of the ribs being a second rib, the second rib being downstream in the flowing direction and being parallel to the first rib; and a turbulent flow generator provided between the first rib and the second rib.

According to one embodiment, a gas turbine includes a blade cooling structure.

Hereinafter, embodiments will be described.

### First Embodiment

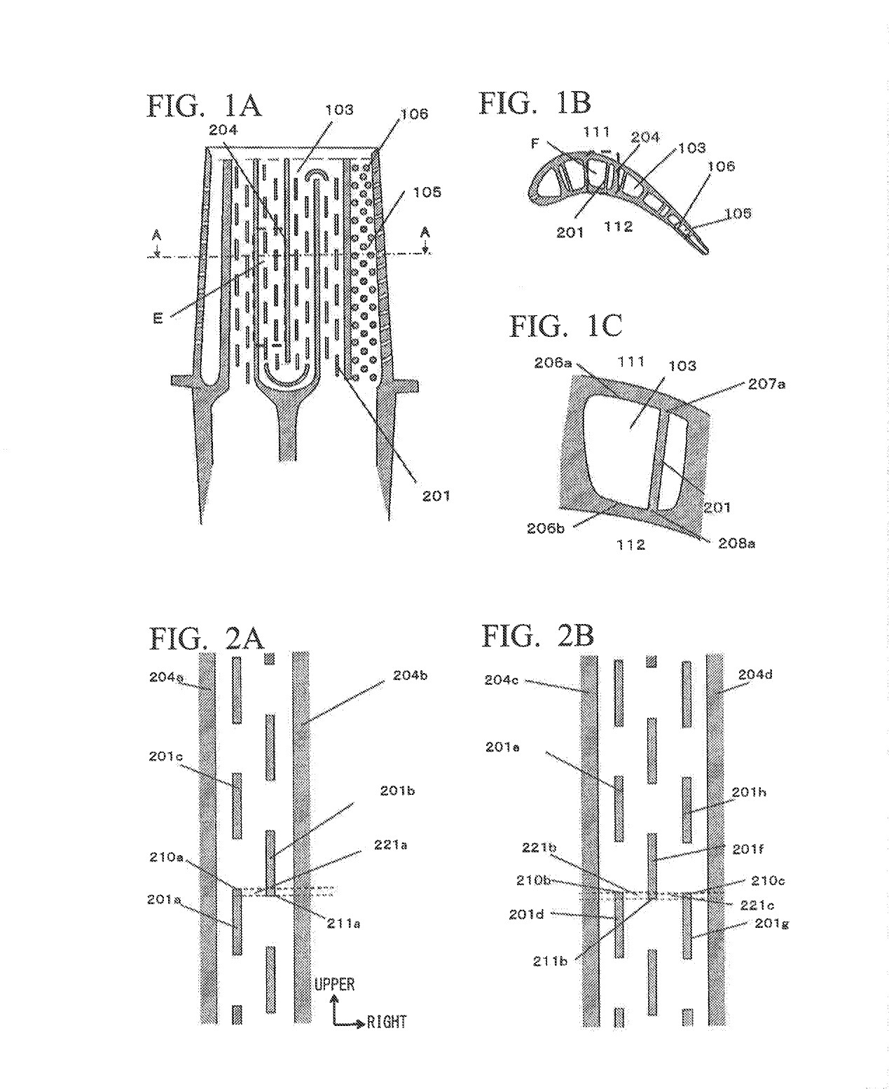

Hereinafter, a configuration of a serpentine cooling medium path in a gas turbine blade according to a first embodiment will be exemplarily described with reference to FIGS. 1A to 3.

Here, description of common parts of the drawings will be omitted.

As shown in FIG. 1A, a serpentine cooling medium path 103 and a pin fin cooling medium path 105, in which a plurality of pin fins 106 are provided at a blade trailing edge, are provided in a blade.

A plurality of ribs 201 having a predetermined length in a flow path direction are disposed in the serpentine cooling medium path 103.

In this case, the fm-shaped ribs 201 are alternately deviated and provided along a plurality of rows substantially parallel to a direction of the flow path 103 or a main stream of a cooling medium.

A configuration in which the ribs are disposed in two rows in a staggered pattern will be described.

FIG. 1B is a cross-sectional view taken along line A-A of FIG. 1A.

FIG. 1C is an enlarged view showing the portion indicated by F of FIG. 1B.

Ends 207a of the ribs 201 are provided in the flow path 103 so as to come into contact with a blade inner wall 206a facing a blade suction side 111, and ends 208a of the ribs 201 are also provided in the flow path 103 so as to come into contact with a blade inner wall 206b facing a blade pressure side 112.

As the ribs are provided in the flow path 103 so as to come into contact with the blade inner walls, the ribs can function as cooling fins.

FIG. 2A is an enlarged view showing the portion indicated by E of FIG. 1A, and an upward direction of the drawing is a downstream side.

Here, a rib 201b (second rib) is disposed to be shifted from the position of a rib 201a (first rib) in a direction of crossing a flow path (rightward) and is disposed to be shifted downstream further than the rib 201a (that is, the position of the rib 201b is shifted from the position of the rib 201a in the downstream direction). As shown in FIGS. 1A and 2A, a plurality of ribs 201a and a plurality of ribs 201b are provided in the serpentine cooling medium path 103.

Particularly, as a trailing edge 210a of the rib 201a is shifted downstream further than a leading edge 211a of the rib 201b, an overlapping portion 221a functioning as a turbulent flow generator is provided. The overlapping portion 221a is located between the trailing edge 210a of the first rib and the leading edge 211a of the second rib.

FIG. 2B shows the case in which the ribs are disposed in three rows in a staggered pattern.

Also similarly in this case, as a trailing edge 210b of a rib 201d (first rib) is shifted downstream further than a leading edge 211b of a rib 201f (second rib), an overlapping portion 221b is formed, and as a trailing edge 210c of a rib 201g is shifted downstream further than a leading edge 211b of a rib 201f, an overlapping portion 221c is formed.

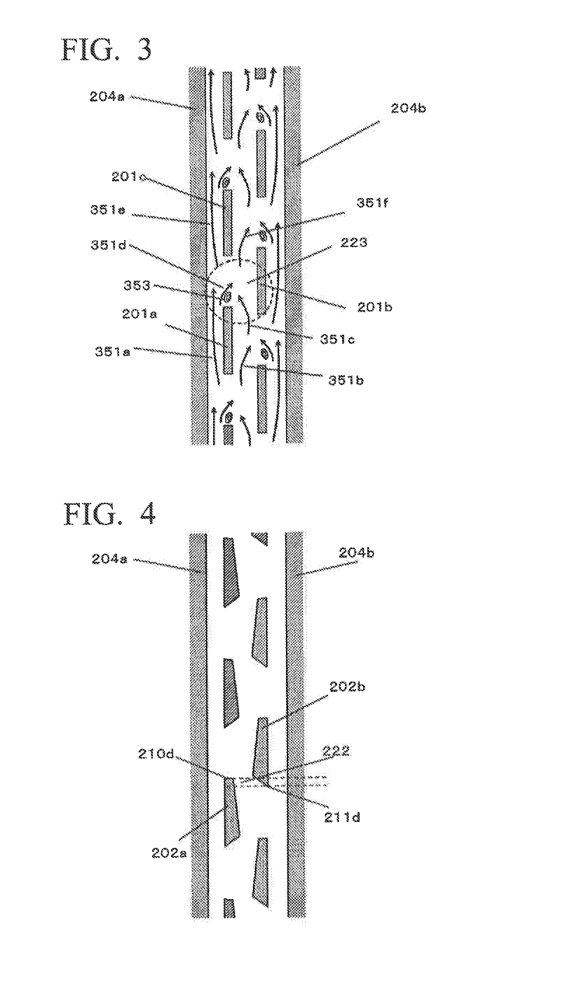

FIG. 3 shows a flow of a cooling medium in a flow path when an overlapping portion is formed.

A vortex 353 is generated at the trailing edge of each of the ribs in the flow path, and each of the ribs functions as a vortex generator.

The flow in the flow path is branched into flows 351a and 351b at the leading edge side of the rib 201a.

The flow 351a is divided into a flow 351d, which is separated at a trailing edge of the rib 201a passing through a region constituted by a flow path partition wall 204a and the rib 201a, and a flow 351e, which passes through a region constituted by the flow path partition wall 204a and the rib 201c.

A part of the flow 351b becomes a flow 351c, and the flow 351c changes its flow direction at a leading edge of the rib 201b to collide with the flow 351d to be mixed with the flow 351d in a mixing region 223.

After that, the flow 351e and a flow 351f flow downstream.

At each of the ribs, the above-mentioned flow is repeated.

As described above, as the flow is changed into a turbulent flow by the rib, a coefficient of heat transfer is increased, heat transfer is promoted, and cooling performance is improved.

As the overlapping portions 221a and 221b shown in FIGS. 2A and 2B are provided, the mixing in the mixing region 223 is further promoted to generate a strong turbulent flow by increasing a flow velocity while varying a direction of the flow 351c flowing between, for example, the ribs 201a and 201b in comparison to the case in which there are no overlapping portions.

The ribs of the embodiment are disposed to be parallel to the direction of the flow path or the main stream of the cooling medium.

For this reason, resistance is reduced and pressure loss is decreased in comparison to the ribs being perpendicular or slightly inclined with respect to the direction of the flow path in the conventional cooling structure.

In addition, since the ribs are provided in the flow path 103 so as to come into contact with the blade inner wall, the ribs also function as cooling fins.

Furthermore, since the vortex 306a and the vortex 306b generated at upstream and downstream sides of the ribs as shown in FIG. 10 are not generated, a local decrease in a coefficient of heat transfer can be prevented, and non-uniformity of cooling performance can be prevented.

According to the above-mentioned gas turbine blade cooling structure, both of an increase in a coefficient of heat transfer and a decrease in pressure loss are achieved, and effective cooling can be performed with a small quantity of air.

As a result, the quantity of air extracted from the compressor can be reduced and the quantity of air sent to the combustor can be increased, and thus, an effective gas turbine can be realized.

### Modified Example of First Embodiment

Hereinafter, a modified example of the turbine cooling blade according to the first embodiment will be described with reference to FIG. 4.

As shown in FIG. 4, for example, one of the side surfaces of a rib 202a which faces the flow path partition wall 204a may be parallel to the flow path or the direction of the main stream, the other of the side surfaces of the rib 202a may be substantially parallel to the flow path. That is, any one of the side surfaces may be only substantially parallel to the flow path, or both side surfaces may be substantially parallel to the flow path.

Similarly, in a rib 202b, only one side surface may be substantially parallel to the flow path or the direction of the main stream, or both of the side surfaces may be substantially parallel thereto.

Here, a trailing edge 210d of the rib 202a is preferably disposed to be downstream from a leading edge 211d of the rib 202b to form an overlapping portion 222.

### Second Embodiment

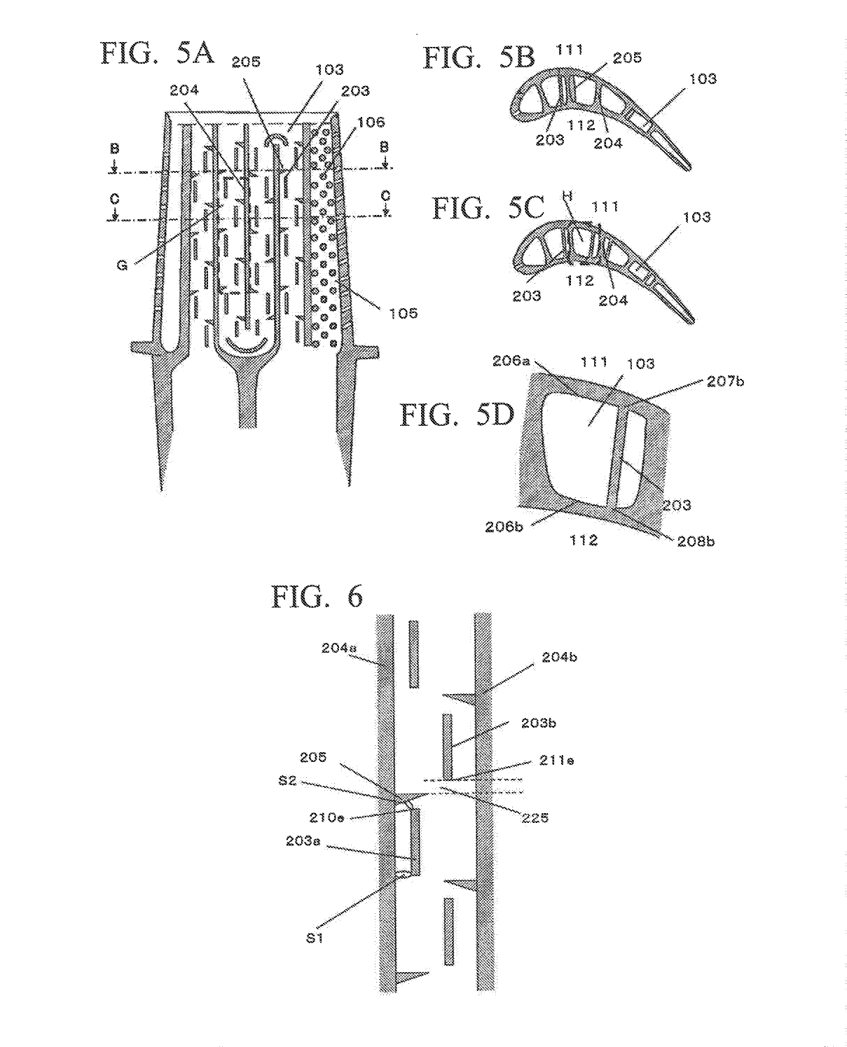

Hereinafter, a configuration of a serpentine cooling medium path of a turbine cooling blade according to a second embodiment will be exemplarily described with reference to FIGS. 5A to 7.

As shown in FIGS. 5A to 5D, in a serpentine flow path 103 provided in a turbine blade, fm-shaped ribs 203 are provided in a plurality of rows parallel to a direction substantially parallel to a flow path in the blade or a direction of a main stream in a staggered pattern.

Furthermore, a protrusion 205 serving as a turbulent flow generator is provided downstream from each of the ribs 203. The protrusion 205 is provided so as to protrude from an inner wall surface of the flow path.

A configuration in which the rigs are disposed in two rows in a staggered pattern will be exemplarily described.

FIG. 5C is a cross-sectional view taken along line C-C of FIG. 5A.

As shown in FIG. 5D serving as an enlarged view showing the portion indicated by H of FIG. 5C, ends 207b (upper end) of the ribs 203 are provided in the flow path 103 so as to come into contact with a blade inner wall 206a opposing the blade suction side 111, and ends 208b (lower end) of the ribs 203 are provided in the flow path 103 so as to come into contact with the blade inner wall 206b opposing the blade pressure side 112.

As shown in FIG. 5B serving as a cross-sectional view taken along line B-B of FIG. 5A, the protrusions 205 are also provided in the flow path 103 so as to come into contact with the blade inner wall. Particularly, the upper ends of the protrusions 205 are provided in the flow path 103 so as to come into contact with a blade inner wall 206a opposing the blade suction side 111, and the lower ends of the protrusions 205 are provided in the flow path 103 so as to come into contact with the blade inner wall 206b opposing the blade pressure side 112.

As the ribs and the protrusions are provided in the flow path 103 so as to come into contact with the blade inner wall, the ribs and the protrusions can function as cooling fins.

In the ribs, as shown in FIG. 6 serving as an enlarged view showing the portion indicated by G of FIG. 5A, a rib 203a is disposed such that a cross-sectional area of a region constituted by the flow path partition wall 204a and the rib 203a is S1, and the protrusion 205 is disposed such that a cross-sectional area between a trailing edge 210e of the rib 203a and the protrusion 205 is S2.

Here, the flow path cross-sectional areas are preferably S1>S2.

It is preferable that a rib 203b (second rib) located downstream from the rib 203a (first rib) be disposed such that a gap 225 is provided between the protrusion 205 and the rib 203b.

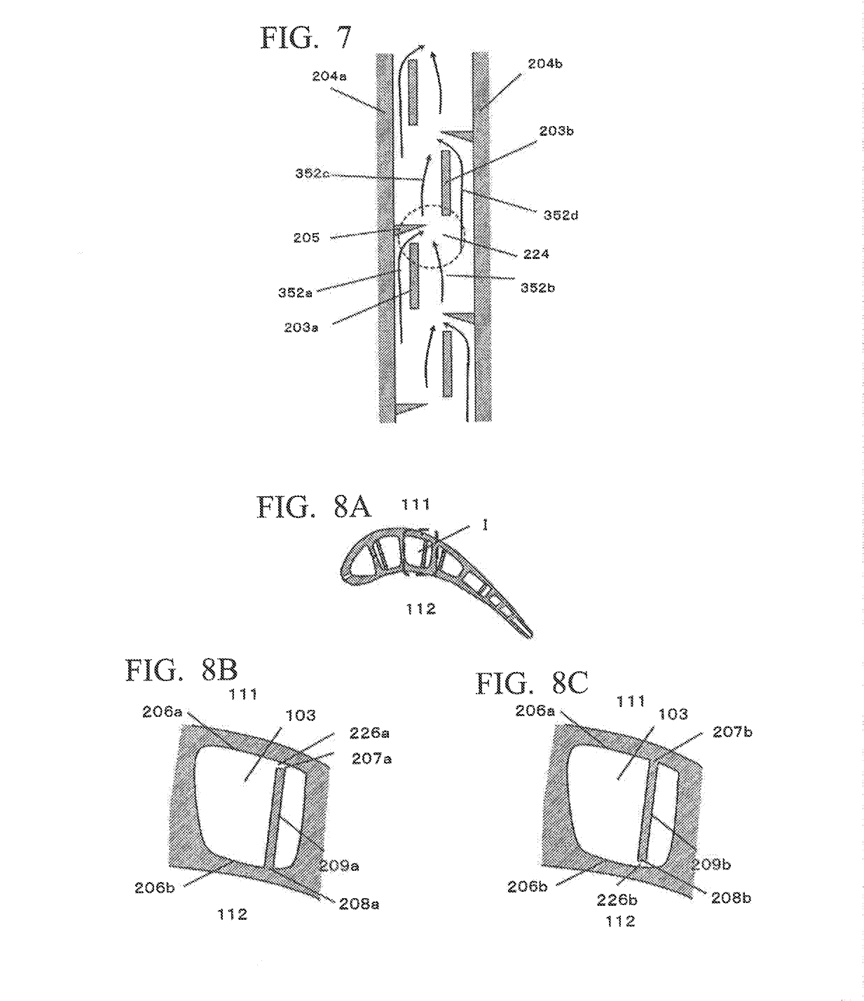

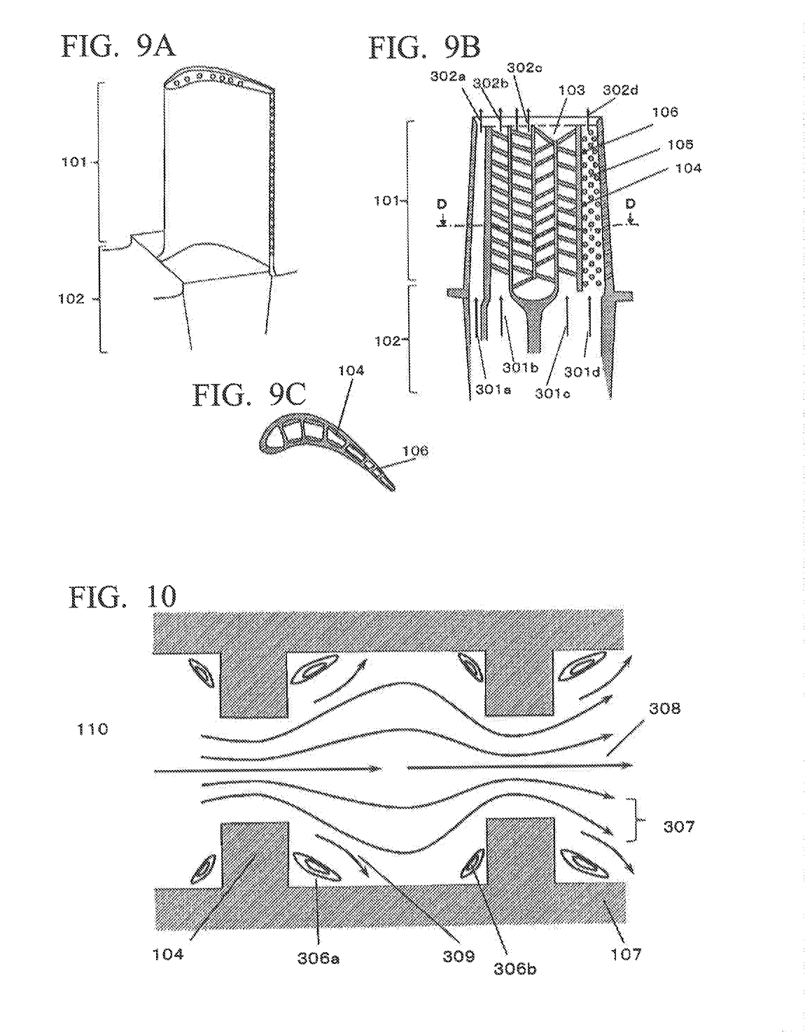

As shown in FIG. 7, a flow 352a branched off into flows 352a and 352b, which pass through the region constituted by the flow path partition wall 204a and the rib 203a and are accelerated by the protrusion 205 to be guided to the vicinity of a center of the flow path by the rib 203a in the flow path.

The flow 352b and the flow 352a collide with each other to be mixed in a mixing region 224.

After that, the flow is branched off into a flow 352c and a flow 352d to flow downstream.

The above-mentioned flow is repeated by each of the ribs and each of the protrusions.

As described above, as the flow is changed into a turbulent flow by the ribs and the protrusions, a coefficient of heat transfer is increased, heat transfer is promoted, and cooling performance is improved.

As shown in FIG. 6, the protrusion 205 is preferably located upstream from a leading edge 211e of the rib 203b of the downstream side to form the gap 225. That is, the gap 225 is provided between the leading edge 211e of the rib 203b and the protrusion 205.

In addition, the flow path cross-sectional areas S1 and S2 are preferably S1>S2.

According to S1>S2, the flow 352a is accelerated when the flow 352a passes through the protrusion, a better mixing effect is obtained, and cooling performance is improved.

Since the ribs of the embodiment are disposed to be substantially parallel to a direction of the flow path or a main stream of a cooling medium, a resistance is decreased and pressure loss is reduced in comparison to the ribs being perpendicular or slightly inclined with respect to the direction of the flow path in the conventional cooling structure.

In addition, since the ribs and the protrusions are provided in the flow path 103 so as to come into contact with the blade inner wall, the ribs and the protrusions can also function as cooling fins.

Furthermore, since the vortices 306a and 306b generated at upstream and downstream sides of the ribs as shown in FIG. 10 are not generated, a local decrease in a coefficient of heat transfer can be prevented, heat transfer is promoted, and non-uniformity of cooling performance can be prevented.

According to the above-mentioned gas turbine blade cooling structure, both of an increase in a coefficient of heat transfer and a decrease in pressure loss are achieved, and effective cooling can be performed with a small quantity of air.

As a result, a quantity of air extracted from the compressor can be reduced, and a quantity of air sent to the combustor can be increased.

### Modified Examples of First and Second Embodiments

Hereinafter, modified examples of the turbine cooling blade according to the first and second embodiments will be described with reference to FIGS. 8A to 8C.

As shown in FIG. 8B serving as an enlarged view showing the portion indicated by I of FIG. 8A, an end 207a (upper end) of a rib 209a may not come into contact with the blade inner wall 206a to form a gap 226a, and the end 208a (lower end) may be provided in the flow path 103 so as to come into contact with the blade inner wall 206b.

In this case, an upper end of a protrusion may not come into contact with the blade inner wall 206a to form a gap 226a, and a lower end of the protrusion may be provided in the flow path 103 so as to come into contact with the blade inner wall 206b.

Similarly, as shown in FIG. 8C, an end 207b (upper end) of a rib 209b may be provided in the flow path 103 so as to come into contact with the blade inner wall 206a, and the end 208b (lower end) may not come into contact with the blade inner wall 206b to form a gap 226b.

In this case, an upper end of a protrusion may be provided in the flow path 103 so as to come into contact with the blade inner wall 206a, and a lower end of the protrusion may not come into contact with the blade inner wall 206b to form a gap 226b.

As shown in FIGS. 8B and 8C, even when only one of the ends of each of the ribs comes into contact with the blade inner wall, the same effect can be obtained as when both of the ends come into contact with the blade inner wall.

Furthermore, when only one of the ends of each of the ribs come into contact with the blade inner wall, flows in the gap 226a between the rib 209a and the blade inner wall 206a and the gap 226b between the rib 209b and the blade inner wall 206b are accelerated.

As a result, a better mixing effect is obtained, heat transfer is promoted, and cooling performance is improved.

As the gas turbine cooling blade having the above-mentioned configuration is provided, an increase in pressure loss caused by an increase in resistance due to the ribs in a conventional structure and non-uniformity of cooling performance caused by the generation of vortices of the upstream and downstream sides of the ribs can be prevented.

Accordingly, both of an increase in a coefficient of heat transfer and a decrease in pressure loss are achieved, and the turbine blade can be effectively cooled with a small quantity of air.

As a result, a decrease in thermal efficiency of the gas turbine caused by an increase in an amount of cooling air can be prevented, and performance of the gas turbine can be improved.

### Other Embodiments

In this specification, while the plurality of embodiments have been described, these embodiments are merely exemplarily provided but not are intended to limit the scope of the invention.

Specifically, both or any one of the first and second embodiments may be combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cooling structure comprising:
a flow path provided in a blade and configured to cause a cooling medium to flow therethrough;
a plurality of ribs provided in the flow path and alternately deviated and provided to be substantially parallel to a flowing direction of the cooling medium, one of the ribs being a first rib, the first rib being upstream in the flowing direction, one of the ribs being a second rib, the second rib being downstream in the flowing direction and being parallel to the first rib; and
a turbulent flow generator provided between the first rib and the second rib.

2. The cooling structure according to claim 1, wherein the turbulent flow generator is an overlapping portion between a rear end of the first rib and a front end of the second rib.

3. The cooling structure according to claim 1, wherein the turbulent flow generator is a protrusion protruding from an inner wall surface of the flow path.

4. The cooling structure according to claim 3, wherein the protrusion is located upstream from a leading edge of the second rib to provide a gap.

5. The cooling structure according to claim 3, wherein a flow path cross-sectional area between the first rib and an inner wall surface of the flow path is larger than a flow path cross-sectional area between a trailing edge of the first rib and the protrusion.

6. The cooling structure according to claim 3, wherein each rib has an upper end and a lower end, the turbulent flow generator is a protrusion that has an upper end and a lower end, and upper ends of the rib and the protrusion and lower ends of the rib and the protrusion are provided so as to come into contact with a flow path wall surface opposite to a back surface and a ventral surface of the blade.

7. The cooling structure according to claim 3, wherein, each rib has an upper end and a lower end, the turbulent flow generator is a protrusion that has an upper end and a lower end, one set of upper ends and lower ends of the rib and the protrusion comes into contact with the flow path wall surface, and the other set of the upper ends and the lower ends does not come into contact with the flow path wall surface to form a gap.

8. A gas turbine comprising the cooling structure according to claim 1.

9. A cooling structure comprising:
a flow path provided in a blade and configured to cause a cooling medium to flow therethrough;
a plurality of ribs provided in the flow path and alternately deviated and provided to be substantially parallel to a flowing direction of the cooling medium, one of the ribs being a first rib, the first rib being upstream in the flowing direction, one of the ribs being a second rib, the second rib being downstream in the flowing direction and being parallel to the first rib; and
an overlapping portion provided between a rear end of the first rib and a front end of the second rib, the overlapping portion being configured to generate a turbulent flow in flow of the cooling medium.
